(19) United States
(12) Patent Application Publication
(10) Pub. No.: US 2004/0172365 A1
(43) Pub. Date: Sep. 2, 2004

(54) Method for performing electronic redistribution of digital content with fee assessment and proceeds distribution capability

(75) Inventors: Kaori Murakami, Sunnyvale, CA (US); Toshio Miki, Cupertino, CA (US); Maki Tsukada, Urayasu-shi (JP)

Correspondence Address: Brinks Hofer Gilson & Lione, NBC Tower, NBC Tower, Suite 3600, P.O. Box 10395, Chicago, IL, 60610, US

(73) Assignee: DoCoMo Communications Laboratories USA, Inc.

(21) Appl. No.: 10/376,433

(22) Filed: Feb. 28, 2003

(51) Int. Cl. G06F 17/60

(52) U.S. Cl. 705/52

(57) ABSTRACT

A digital content provider, representing an author, provides copyright-protected digital content data and a metadata file appended to it for the electronic distribution of the digital content over a network. The electronic distribution metadata describes various data about the digital content such as the title, the author, the content provider, the royalty, and the redistribution parameters. A primary content receiver receiving the digital content and the metadata, generates and transmits a notice of completion based on the metadata parameters. Upon receipt, an electronic distribution management system within a service provider (xSP) provides fee assessment and proceeds distribution services. Should the primary receiver transfer the content to a secondary receiver, the electronic distribution management system will equitably distribute the fees amongst the parties to the transaction when the notice of completion is received, thereby rewarding the owner of the copyright as determined by the redistribution parameters within the metadata.

### BACKGROUND

Recently, software for enabling the free exchange of copyrightable material such as music files, books, and most recently, movies in digital format has been distributed over the Internet and used to download copyrightable material onto computers for individual use. The content receiver simply purchases blank storage media such as compact disks (CD) and records the content free of charge without becoming a member of any fee-based online sales site. Although the practice was originally aimed at digital music files, it is now readily practiced by utilizing the digital video disc (DVD) technology to copy movies. Thus, a continuous flow of software packages for performing free exchange of digital content is continually becoming available. This has created an environment where paying the asking price for digital content becomes rare, and the copyright protection of that digital content is very difficult.

Since the early days of this practice, free file exchange software is now subject to legal restrictions, imposed to reduce illegal file exchange activity. Also, a strong copyright protection measure has recently come into use whereby music files are recorded with digital watermarks inserted to prevent the unauthorized output of the recorded files to compact disks. Thus a variety of standards and other means have been devised for the protection of copyright, including means for preventing unauthorized output to other media, redistribution to third parties, and modification of content.

From the standpoint of the content receiver, this trend has been detrimental to the content receiver's environment and the conditions that the receiver must meet in order to receive the copyrightable material or digital content. As a result, there has been a sharp reduction in the volume of digital content distributed, including that content which is distributed through the purchase of recording media such as compact disks. This in turn has reduced the financial rewards received by content providers and copyright owners. Accordingly, a balancing between the need to protect and compensate copyright owners and the unlimited availability of digital content to the public must be made.

### BRIEF SUMMARY

This method provides a process for ensuring the equitable assessment of fees to the user, and the distribution of proceeds to the authors or intellectual property right owners, when any copyright-protected digital content is purchased over a network and is subsequently redistributed by the primary recipient to a predetermined number of potential recipients. The potential recipients, for example, may be other computers or devices connected to the Internet where the access and the distribution of the digital content is provided. According to an aspect of the invention, the electronic redistribution of content, rather than preventing the practice altogether, is provided through a method of fee assessments and the distribution of proceeds once permission for the distribution of the protected work is granted based on established policies. Therefore, copyrights are honored by royalty payments to the content providers, who represent the authors or distribution agents. Redistribution by the original purchasers may be authorized and payment of intermediary fees to the primary content receivers is provided within the parameters of the amount of redistribution authorized by the content owner. In order to do this, two general processes are involved.

In one embodiment, the electronic distribution metadata is appended to the digital content and the protected digital content is distributed to a content receiver or consumer. When copyright-protected digital content has been received from a content provider, the initial recipient otherwise known as the primary content receiver will automatically transmit a notice of completion of electronic distribution to an electronic distribution management system operated within an xSP service provider. The automatically generated notice of completion is based on the information contained in the electronic distribution metadata. The xSP service provider provides services of the “x” type, those representative of the services that DoCoMo® would provide. The xSP service provider charges or provides a fee assessment against a receiver for the copyright-protected digital content that the receiver has obtained and then distributes a share of the fee or proceeds to the copyright owner. The digital content may be received at either a primary or secondary content receiver, or in another embodiment, a used content store. The xSP reacts to the notice of completion that was transmitted by the receiver upon receipt of the digital content. The xSP comprises an electronic distribution management system, a fee assessment/proceeds distribution system and a receiver/provider management system. Any network service provider or a digital content provider may provide the services of the xSP.

The electronic distribution of digital content does not always involve distributing the entire copyright-protected content. For example, when one uses a cash server, the distribution of only a portion of the data, such as the playback data that is based on public key encryption, might be performed. In this case, only a portion of the content is distributed for that limited purpose.

The electronic distribution management system within the xSP has programs for processing the information received in the notice of completion, and it issues fee assessment and proceeds distribution processing instructions to the fee assessment/proceeds distribution system. The fee assessment/proceeds distribution system accesses the receiver/provider management system within the xSP, and will perform the fee assessment and proceeds distribution for that receiver and the particular provider of the digital content. In this process, the content receiver is assessed a fee for the content distribution.

In an alternative embodiment, the digital content received and used by one computer terminal or digital device is subsequently redistributed to a secondary receiver. The secondary receiver may be another computer terminal or another mobile device capable of using the copyrightable material. The content receiver, after receiving the copyright-protected digital content from a content provider or a primary content receiver, acknowledges the reception by transmitting a notice of completion to the electronic distribution management system operated within the xSP network. The system will perform the fee assessment and proceeds distribution processing services as described previously. If the content receiver is authorized to redistribute the copyright-protected content, the metadata will reflect that authorization for a predetermined number of secondary content receivers or group terminals.

The distribution and redistribution of digital content is not limited to a wired network such as the Internet. It may also be distributed through the major telecommunication companies such as the long-distance carriers and regional telephone carriers. With the wireless telephone companies providing access to the Internet through cellular phones, individuals can get access to copyright-protected content just about anywhere. Even personal computers may acquire the digital content through IEEE 802.11 standardized wireless local area networks. It is intended that digital content distributed by wireless networks, such as that employing an equivalent to the Bluetooth™ wireless technology or peer-to-peer communication using infrared radiation, are also within the scope of this invention. As for the method of redistribution, the digital content may be distributed in its entirety, or when using a cash server, only a portion of the data, such as a public key-based playback protocol or its equivalent.

Four fee assessment patterns are provided for the assessment of content redistribution fees, with the selection of the pattern based on such factors as user preferences, and the fee assessment policy and service model of the xSP. In the “a” pattern, a notice of completion of electronic redistribution is automatically transmitted from the receiver of the redistributed content (the secondary content receiver) to the electronic distribution management system after the content has been redistributed. Based on this notice, assessment of third party collection fees and the distribution of proceeds is performed by the system. In the “b” pattern, before the content is redistributed, the fee assessment signal is sent to the secondary content receiver, and if an advance fee assessment is obtained, the redistribution is approved. In the “c” pattern, after the content has been redistributed, a notice of receipt is sent from the secondary content receiver to the primary content receiver, and the fee is assessed against the primary content receiver. In the “d” pattern, before the content is redistributed, the fee is assessed against the primary content receiver, and when the advance fee assessment is obtained, the redistribution will be approved.

### BRIEF DESCRIPTION OF THE DRAWINGS

The method for the electronic redistribution of copyright-protected digital content with fee assessment and proceeds distribution can be better understood with reference to the following drawings and descriptions. The components in the figures are not necessarily to scale, the emphasis instead being placed upon illustrating the principles of the invention. Moreover, in the figures, like reference numerals designate corresponding parts throughout the different views. In the drawings:

FIG. 1 shows an example of a network configuration for implementation of the present invention;

FIG. 2 describes the type of information that is provided in an electronic distribution metadata file;

FIG. 3 shows an example of a network interconnect configuration for redistribution of music content to a third party;

FIG. 4 is an operational flow diagram for the redistribution of received music content to a third party utilizing the network of FIG. 3;

FIG. 5 shows an example of a network configuration for the buying and selling of surplus digital content through an agent; and

FIG. 6 is an operational flow diagram for trading surplus digital content through the network of FIG. 5.

### DETAILED DESCRIPTION OF THE DRAWINGS AND PRESENTLY PREFERRED EMBODIMENTS

The disclosed invention describes a system that provides a method and apparatus for ensuring the equitable assessment of fees and the distribution of proceeds to the creators of intellectual property, generally copyright-protected material, and the owners of the intellectual property rights, especially when this protected material is digitized for storage and reproduction through electronic means and subsequently transferred electronically over a network. The primary recipient, the user of a computer terminal or other digital device, of the copyright-protected digital content may redistribute this material to a predetermined number of other recipients (including mobile terminals, etc.) for their use, if that transaction is authorized. This material may include software, music, books or movies or any other material where the creator has a legally protected interest. The digital content may originate from digital video disc, compact disc or an MP3 format; it is not necessary to initially receive the digital content from over the Internet. In order to provide an environment where the user obtains the efficient use of the protected digital content in a timely manner, and reward the vested owner for the creative efforts, the following system and method are disclosed.

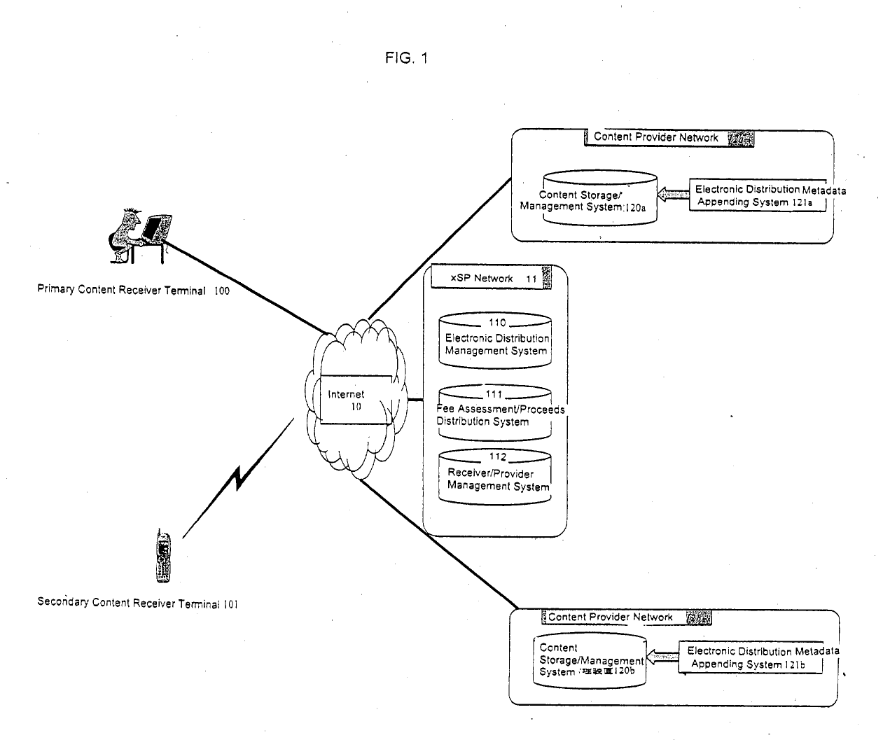

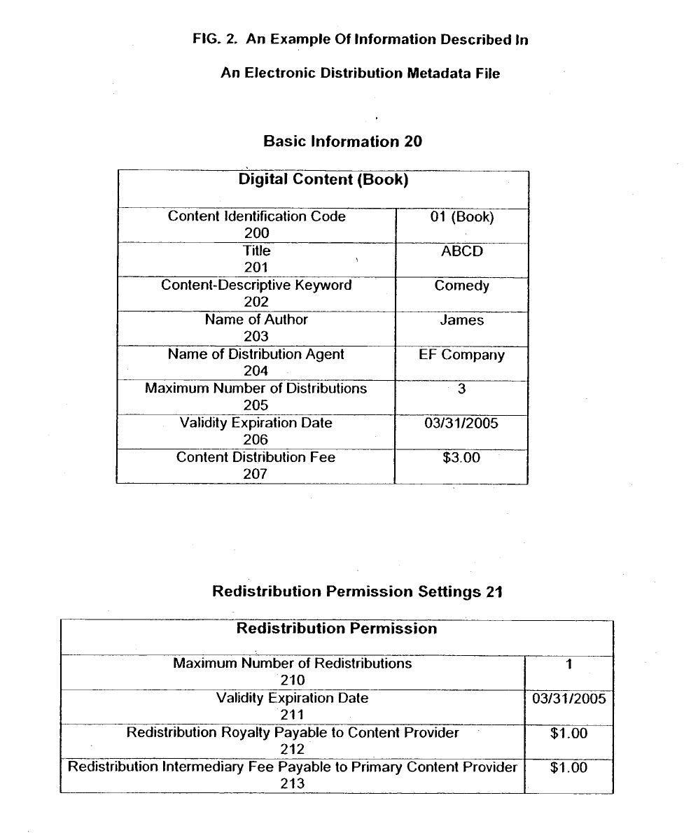

To implement the present invention, there must be an appropriate interconnect configuration, such as the Internet, between the networks related to the functions being performed. A possible configuration for one embodiment of the network relating to the functions of the present invention is described in FIG. 1. The parameters of the metadata information are shown in FIG. 2. The first described embodiment of the interconnection includes an xSP service provider 11 comprising an electronic distribution management system 110, a fee assessment and proceeds distribution system 111, and a receiver/provider management system 112.

The xSP manages the distribution of the copyright-protected digital content via a network 10, such as the Internet. The xSP's electronic distribution management system 110 has programs for processing the electronic distribution and redistribution completion notices transmitted from content receivers 100 and 101. The electronic distribution management system 110 also contains programs for issuing fee assessment and proceeds distribution processing instructions to a fee assessment/proceeds distribution system 111. The fee assessment and proceeds distribution system 111 receives the instructions from the electronic distribution management system 110, and accesses a receiver/provider management system 112 for performing fee assessment and proceeds distribution processing. The receiver/provider management system 112 provides reference data about the content provider, the content receivers, and any other terminals belonging to the primary receiver for which redistribution by the primary content receiver is authorized. This would be analogous to a license for software where only one copy of the software disc was purchased, but the owner of the disc obtained a license for multiple computers to have the program.

Also shown in FIG. 1 are two content provider networks 12a and 12b for storing and managing copyright-protected digital content for the purpose of providing that content over a network 10, such as the Internet. The content provider networks comprise electronic distribution metadata appending systems 121a and 121b, which appends the electronic distribution metadata to the digital content of a given copyright-protected property, and content storage/management systems 120a and 120b for storing and managing the copyright-protected digital content that has an electronic distribution metadata appended file. Here, the content provider networks 12a and 12b might represent different companies such as book publishers or music recording companies.

The information contained in the electronic distribution metadata is described with reference to FIG. 2. The metadata file contains the basic information 20 about the copyright-protected digital content file. In this example, the data includes information representing a book, which is described as the Content ID code 200. The Content ID code 200 could refer to a song, an album, a movie or even a television show. Other items within the metadata file include the title of the work 201, a content descriptor keyword 202, the name of the author 203, the name of the distribution agent 204, the maximum number of distributions allowed 205, the content validity period expiration date 206, and the content distribution fee payable to the content provider 207.

Also included within the metadata file are the redistribution permission settings 21. This setting includes the maximum number of redistributions to third parties 210 that a purchaser of the digital content file is allowed to make for a predetermined price. The redistribution validity period expiration date 211, the redistribution royalty payable to the content provider 212, and the redistribution intermediary fee payable to the primary content receiver 213 represent other information that can be contained within the metadata file. The electronic distribution metadata will disallow execution of a redistribution process if the redistribution is not provided for in the metadata settings. For example, if the attempted redistribution would cause the maximum number of distributions to be exceeded, the electronic distribution metadata would automatically facilitate the deletion of the digital content from a terminal that received an unauthorized distribution. In addition, if the term of validity expired, the metadata would facilitate the deletion of the digital content from the content receiver.

The method for appending the electronic distribution metadata is one commonly used among xSPs and software developers, such as the direct entry in eXtensible Markup Language (XML), etc., or an easier entry method for general users, wherein an interface of the type used for authoring web pages is provided, and the user simply enters the required information as parameter inputs. Codes used in metadata are also selected as codes commonly used among xSPs and software developers. However, this invention is not limited to the commonly used languages. These appending functions for the metadata are implemented via the electronic distribution metadata appending system 121a and 121b in FIG. 1.

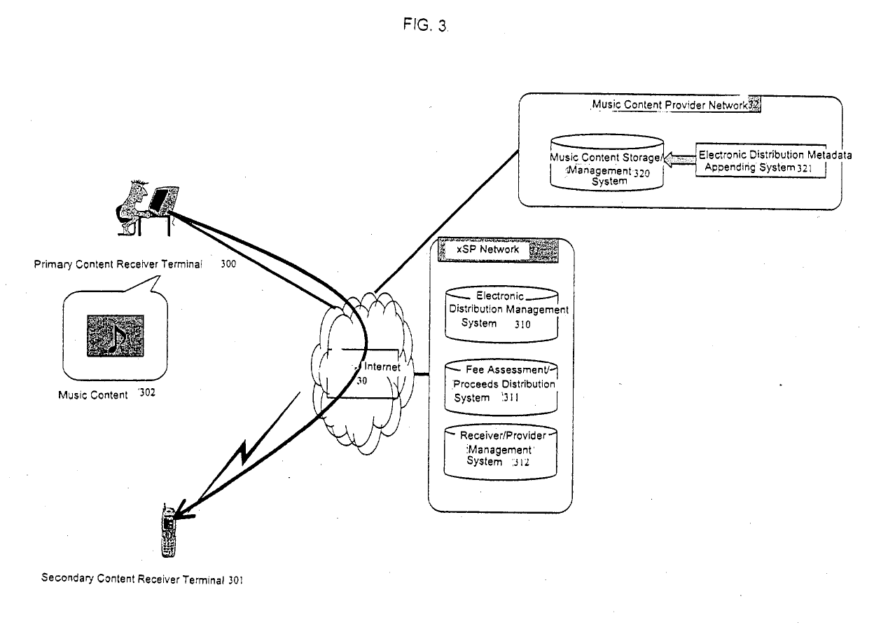

There are many ways to carry out the invention and two embodiments of the disclosed invention are described below. The first embodiment describes the fee assessment and the proceeds distribution function where received copyright-protected digital content is redistributed to another terminal. For the sake of clarity, the copyright-protected digital content could be a musical selection, or the book mentioned earlier, received by a content receiver and redistributed to a third party. FIG. 3 illustrates the interconnect configuration for implementing this embodiment.

The configuration of the network includes an xSP network 31 capable of providing fee assessment and proceeds distribution via a network 30, such as the Internet. The xSP network 31 comprises an electronic distribution management system 310, a fee assessment/proceeds distribution system 311 and a receiver/provider management system 312. The electronic distribution management system 310 has programs for processing the electronic distribution and redistribution completion notices transmitted from the primary content receiver terminal 300. Within these programs is a function for issuing fee assessment and proceeds distribution processing instructions to the fee assessment/proceeds distribution system 311. The instructions are transmitted to the fee assessment/proceeds distribution system 311 that access the receiver/provider management system 312 for performing fee assessment and proceeds distribution processing. The receiver/provider management system 312, provides reference data on the content receivers and providers.

The music is provided by a content provider network 32. The music is stored and managed within the content provider network 32. Its purpose is for sourcing music content over a network 30, such as the Internet. The content provider 32 comprises an electronic distribution metadata appending system 321 and a content storage/management system 320. The electronic distribution metadata appending system 321, appends the electronic distribution metadata to the music content. The content storage/management system 320 stores and manages the music content which has the electronic distribution metadata appended to it. Also shown in FIG. 3 is a secondary content receiver terminal 301 to which the content receiver terminal 300 redistributes the music content 302.

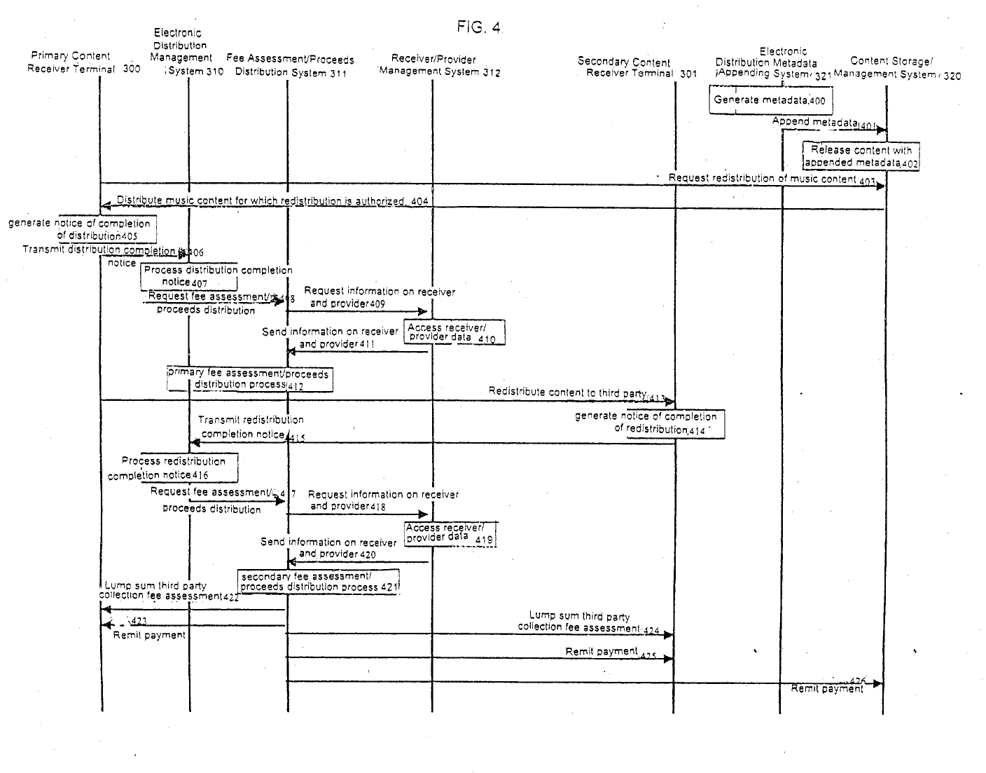

In order to better understand the redistribution of the music to the secondary receiver and how the fees are assessed, the operational flow diagram in FIG. 4 is referenced. This method pattern is known as “a” pattern. This pattern is characterized when a notice of completion of electronic redistribution is automatically transmitted from the receiver of the redistributed content (the secondary content receiver) to the electronic distribution management system after the content has been redistributed.

Initially, a music content provider, such as the composer or an authorized distribution agent arranging distribution of the content through an online music sales site, utilizes the electronic distribution metadata appending system 321 and generates an electronic distribution metadata file for the music content 400. Included in this metadata, in addition to the basic metadata information, are the redistribution authorization settings for the maximum number of redistributions permitted, the validity period for the redistribution rights, the redistribution royalty payable to the content provider, as well as the redistribution intermediary fee payable to the primary receiver. The electronic distribution metadata is appended to the corresponding content 401, and the content with its appended metadata is released over a network such as the Internet 402 for delivery to the recipient. The network may be a wireless network such as the Bluetooth™ wireless network or an infrared system for peer-to-peer communications.

When the primary content receiver 300 desires music, it transmits a request to the content storage/management system 320, asking to receive the music content for which redistribution to a third party has been authorized 403. Upon receiving this request, the content storage/management system 320 transmits the requested content to the primary content receiver for which redistribution to a third party is authorized 404. When it receives the requested music content, the primary content receiver terminal 300 automatically generates a notice of completion of distribution 405, and transmits the notice to the electronic distribution management system 310, 406. The electronic distribution management system 310 performs a notice content analysis program process 407, and issues the fee assessment and proceeds distribution instructions to the fee assessment/proceeds distribution system 311, 408. The fee assessment/proceeds distribution system 311 requests information on the content receiver and provider from the receiver/provider management system 312, 409, whereby the receiver/provider management system 312 accesses its data, based on the request 410, and transmits the requested information to the fee assessment/proceeds distribution system 311, 411. Based on the data it receives, the fee assessment/proceeds distribution system 311 performs a primary fee assessment/proceeds distribution process 412. Simultaneously, the electronic distribution management system 310 issues an encryption key to the terminal of the primary content receiver.

The primary content receiver 300 redistributes the music content to the third party 413, causing the third party, in this embodiment the secondary content receiver terminal 301, to automatically generate a notice of completion of redistribution 414 and transmit it to the electronic distribution management system 310, 415. When the notice of completion is received, the electronic distribution management system 310 processes the redistribution notice of completion 416, and issues fee assessment and proceeds distribution instructions to the fee assessment/proceeds distribution system 311, 417. The fee assessment/proceeds distribution system 311 requests information about the content receiver and provider from the receiver/provider management system 312, 418, the receiver/provider management system 312 accesses the data, and based on the request 419, transmits the requested information to the fee assessment/proceeds distribution system 311, 420. Simultaneously, the fee assessment/proceeds distribution system 311 instructs the electronic distribution management system 310 to issue the encryption key required for playback of the content. Depending upon the reply from the receiver/provider management system 312, the fee assessment/proceeds distribution system 311 performs a secondary fee assessment/proceeds distribution process 421. At this time, the electronic distribution management system 310 issues the required key for playback of the music to the secondary content receiver terminal 301. The fee assessment/proceeds distribution system 311 then assesses the lump sum third party fees against the primary content receiver terminal 300 and the secondary content receiver terminal 301, 422 and 424, and concurrent with the acceptance of the payment 423 and 425, pays the third party collection fees to the music content storage/management system 320, 426. The potential exists for the parties to be involved in a multitude of transactions. The settling of the accounts between these parties may be performed by offsetting the fee of one party against the fee of another party to the transaction. Further, these payments might be reduced by regular periodic payments to the digital content provider.

For an alternative payment arrangement during the transaction, the payment process for the content provider 320 might be performed after the completion of the primary fee assessment/proceeds distribution process 412. The distribution of the payment from the secondary receiver would still take place after the completion of the secondary fee assessment/proceeds distribution process 421. Also, when lump sum third party fees are assessed following the completion of the secondary fee assessment/proceeds distribution process, the amount of the commission for the primary content receiver will be deducted from the content redistribution fee. The redistribution fee includes a payment or commission to the primary content receiver for providing the sale to the secondary receiver. The redistribution fee also reflects the reduced value of the primary content receiver's value in the digital content because of the redistribution transaction.

When the fee assessment for the above redistribution of digital content is performed according to assessment pattern ‘b,’ then before performing step 413, a signal, indicating that redistribution from the primary content receiver 300 to the secondary content receiver terminal 301 is authorized, is sent to the electronic distribution management system 310, and the redistribution is not enabled until after the fee assessment process has been completed. In patterns ‘c’ and ‘d,’ the destination for fee assessment signals would be the primary content receiver terminal 300. In the “c” pattern, when the content has been redistributed, a notice of receipt is sent from the secondary content receiver 301 to the primary content receiver 300, and the fee is assessed against the primary content receiver. In the “d” pattern, before the digital content is redistributed, the fee is assessed against the primary content receiver 300, and when the advance fee assessment is obtained, the redistribution will be approved.

To prevent the improper redistribution of content by the primary content receiver for the sole purpose of increasing the third party surcharges that might be collected, a verification step providing a receipt acknowledgement by the secondary content receiver can be added. Also, for redistribution performed in an ad hoc mode, when the fee assessment cannot be performed in real time, a step can be added whereby the delivered content is restricted to play only a portion of the content until the fees are collected, such as a try-before-buy mode.

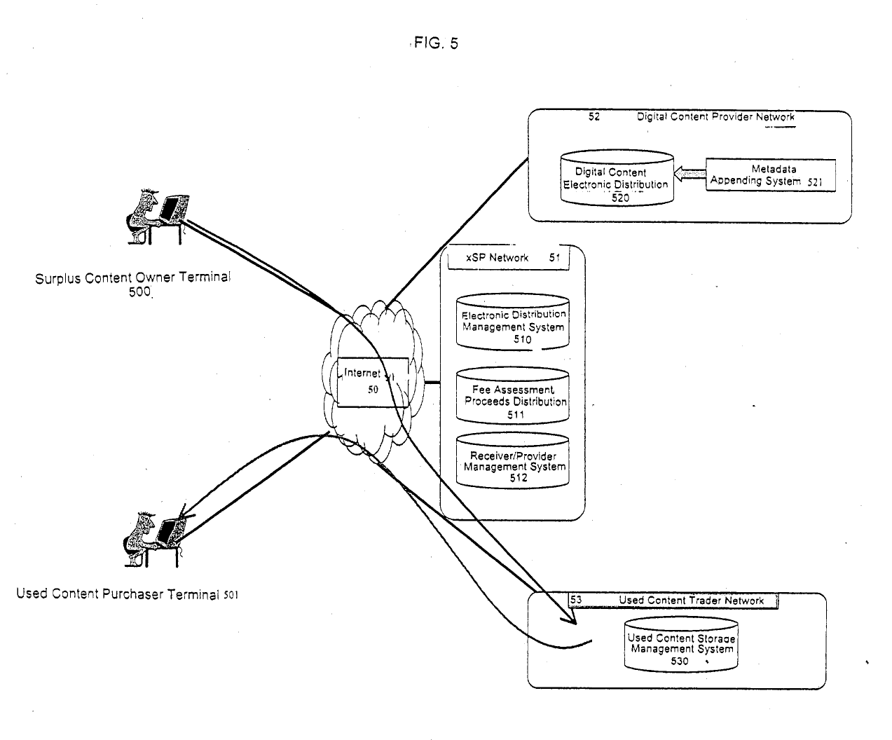

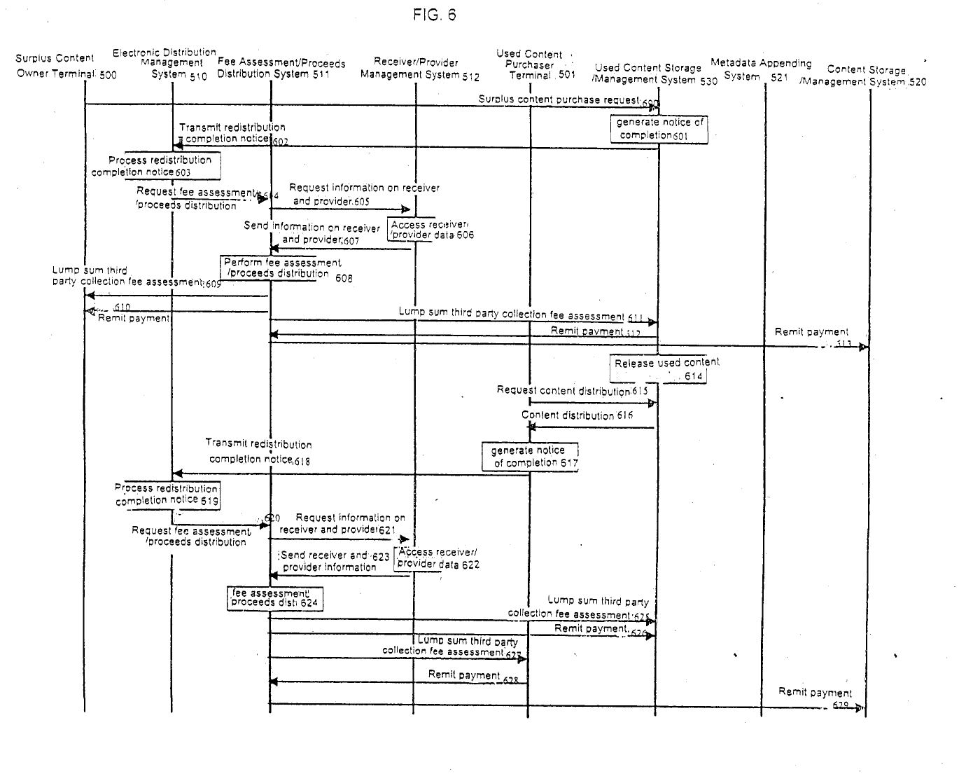

Another embodiment of the disclosed invention describes the process of a used digital content store first buying the digital content from a receiver who previously purchased the content and now has no more use for it. The used content store, at the future request of a potential buyer who desires the used content, may redistribute that digital content according to the previous embodiment. In FIG. 5, the used digital content store 53 has now taken the position of the primary content receiver 300 as described in the previous embodiment and the potential buyer, or used content purchaser, the position on the secondary receiver. However, the used content purchaser 501 could have all the privileges that the primary receiver 300 in the previous embodiment had as dictated by the appended metadata, or it may only have the rights of a secondary receiver. Generally, the used content store keeps the distribution rights that were previously accorded the primary receiver. FIG. 6 is a description of the operational flow for this embodiment.

Within the network is an xSP service provider 51 functioning as a fee assessment and proceeds distribution service provider via a network 50, such as the Internet. The xSP comprises an electronic distribution management system 510, a fee assessment/proceeds distribution system 511, and a receiver/provider management system 512. The electronic distribution management system 510 has programs for processing the electronic distribution and redistribution completion notices transmitted from the surplus content owner terminal 500. It also provides a function for issuing the fee assessment and the proceeds distribution processing instructions to the fee assessment/proceeds distribution system 511. The fee assessment/proceeds distribution system 511, after receiving the instructions, accesses the receiver/provider management system 512 and performs the fee assessment and proceeds distribution process. The receiver/provider management system 512 provides reference data about the content receivers and providers.

Included within the network 50, which may be an Internet-type system, is a content provider network 52 for storing and managing digital content for the purpose of providing that digital content over the network 50. The content provider 52 comprises an electronic distribution metadata appending system 521 for appending the electronic distribution metadata to digital content and a content storage/management system 520 for storing and managing the digital content along with the electronic distribution metadata that is appended to it.

Attached to the network 50 is the used digital content store network 53 for buying and selling used digital content no longer needed by the original purchaser. The used digital content store network 53 comprises a used digital content storage/management system 530 for storing the content in a database system, and a processor that manages the used digital content and determines the market value of the used content. The used content store comprises a used content storage/management system that further comprises a database to store used digital content with appended metadata purchased from a surplus content owner and a processing unit that is in communication with the database. The processing unit contains instructions for negotiating a purchase price with a surplus content owner and a sale price with a surplus content purchaser. The processing unit will further manage the purchase and sale of the used digital content through a network system by communicating with an xSP service provider by implementing some of the procedures similar to the first embodiment.

The used content storage/management system 530 negotiates a price with the surplus content owner 500 for the rights to the used content. It determines the price for the digital content based upon information in the appended metadata file that contains the remaining residual rights of the surplus holder due to usage such as redistribution of the material to other secondary content receivers 301. The used content store 53 may purchase all of the rights for redistribution or the limited amount remaining to the surplus content holder. In this respect, the used content store 53 steps into the position of the surplus content holder 500 whether the holder was originally a secondary 301 or primary content receiver 300. Upon a successful transaction, the privileges that the particular content holder had for the digital content are transferred to the used content store 53.

The value of the digital content may change because of newer versions or editions to the basic product, or because the market for the product has been reduced substantially. Further, the product may not be selling well, or alternatively, there may be great demand for the product. It is anticipated that the used content store 53 will have this information available to it based on the prior sales and purchases of the given used digital content. This information is evaluated and analyzed by the used content store 53 to properly set the market price. Unlike the auction and reverse auction methods utilized by YAHOO™, E-BAY™, and PRICELINE™, these systems determine the price based on past transactions and the amount of trafficking within the given used digital content and are entirely software driven.

Other factors to be considered in determining and negotiating the price include the historical number of sales of the digital content, the number of digital content rights that have been purchased by the used content store 53 and the number of rights residing within the database of the used content store 53. The combining of the above information is considered to be the quality assessment for the digital content. Light demand for the content dictates a lower price for a transaction between a surplus content holder 500 and the used content store 53, and the used content store 53 keeps this transactional information on record to provide up to the minute pricing.

Therefore, the used content storage/management system processing unit will contain instructions for analyzing and utilizing the information in the appended metadata for the used digital content and use that information to negotiate the purchase price of the used digital content from a surplus content owner and the selling price of the used digital content to a used content purchaser. The used content/storage management system processing unit contains instructions that will also obtain, analyze and utilize the quality assessment of the used digital content as described above and will also use that information to negotiate the purchase price of the used digital content from a surplus content owner and the selling price of the used digital content to a used content purchaser. The used content storage/management system processing unit will contain instructions to automatically generate and transmit a notice of completion to an electronic distribution management system 510 in an xSP 51 for a fee assessment and a proceeds distribution after the used content storage/management system 530 receives and stores the used digital content in the database.

The used digital content store 53 may be located within the xSP 51, a digital content provider 52 or any other service provider that may desire to provide this service. Within the network 50 it is intended that there will be a used content purchaser terminal 501 for purchasing the used digital content from the used digital content store 53. The used content store 53 subsequently acts as a clearinghouse for excess digital content for a nominal fee, and provides an available exchange for those who do not want to pay the original purchase price for older content and those who wish to sell their unused copyright-protected material.

With reference to FIG. 6, the operational flow sequence of a transaction for this embodiment will be described. The transaction begins with a surplus content purchase request from the surplus content owner terminal 500 to the used digital content storage/management system 530, which previously acquired from the content storage/management system 520 the digital content to which metadata has been appended by the electronic distribution metadata appending system 521. Upon acceptance of the surplus content purchase request 600, the used digital content storage/management system 530 automatically generates a notice of completion of electronic distribution 601, and transmits it to the electronic distribution management system 510, 602. Since the digital content is used, steps may also be added to the present process in order to allow for negotiations between the used content storage/management system 530 and the surplus content owner terminal 500 for setting prices, based on marketability due to the number of possible playbacks remaining, redistribution royalties, and validity period expiration dates.

After receiving the completion notice, programs within the electronic distribution management system 510 process the information contained within the received notice of completion 603, and issue the fee assessment and proceeds distribution processing instructions to the fee assessment/proceeds distribution system 511, 604. The fee assessment/proceeds distribution system 511 will then request information about the content receiver and provider from the receiver/provider management system 512, 605. The receiver/provider management system 512 accesses its data, and based upon the request 606, transmits the requested information to the fee assessment/proceeds distribution system 511, 607. Simultaneously, the electronic distribution management system 510 will disable the playback capability for that content at the surplus content owner terminal 500.

Following the above process, the fee assessment/proceeds distribution system 511 levies a lump sum third party fee assessment on the surplus content owner terminal 500 and the used content storage/management system 530, 609 and 611, and accepts the payments 610 and 612, and concurrently remits those payments to the digital content storage/management system 520, 613. The used content storage/management system 530 will then release the used content with the appended metadata over the network 614. At the time the content is released, the price is set, corresponding to the marketability of the used content, and the difference from the original version is subtracted, due to the downgrade of the product resulting from prior use. The copyright owner's input for pricing is taken into consideration in the price determination.

When satisfied with the price, the used content purchaser terminal 501 transmits a request to the used content storage/management system 530 indicating a desire to purchase used digital content 615. Upon receiving the request, the used content storage/management system 530 transmits the used digital data content 616. When it receives the used digital content, the used content purchaser terminal 501 automatically generates a notice of completion of electronic distribution 617 and sends it to the electronic distribution management system 510, 618. The electronic distribution management system 510 processes the information contained in the notice 619, and issues the fee assessment and proceeds distribution instructions to the fee assessment/proceeds distribution system 511, 620. The fee assessment/proceeds distribution system 511, requests information about the used content purchaser and content provider from the receiver/provider management system 512, 621, wherein the receiver/provider management system 512 accesses its database. After processing the request 622, the receiver/provider management system replies to the fee assessment/proceeds distribution system 511 with the requested information 623. The fee assessment/proceeds distribution system 511 performs fee assessment/proceeds distribution processing based on that information 624, and the electronic distribution management system issues to the used content purchaser terminal, the encryption key required for playback of the content. Following this process, the fee assessment/proceeds distribution system 511 levies the lump sum third party fee assessments on the used content purchaser terminal 501 and the used content storage/management system 530, 625 and 627, and will accept the payments from both 626 and 628.

Alternatively, the sale transaction by the used content owner 608 and the purchase transaction by the used content purchaser 615 and 616 may be performed simultaneously. Also, the royalty payment to the content provider 613 may be accomplished after the purchase by the used content purchaser 629 has taken place. The potential exists for many transactions. In order to simplify the settling of the accounts between these parties, the offsetting of one party's fee against the fee of another party to the transaction is envisioned within these embodiments. Further, these payments might be reduced as a result of negotiations by regular periodic payments to the digital content provider.

As might be evident from the above description, the adding of electronic distribution metadata to the copyright-protected digital content, and the performance of fee assessment and proceeds distribution over a network does not totally prevent acts of altering the content, copying it to other media, or redistributing it to third non-paying parties. The disclosed method does protect digital content by providing the capability, once permission for use has been granted by the process based on the electronic distribution metadata processing method, to effect the payment of royalties to the content provider, for the amount of use authorized.

It is therefore intended that the foregoing detailed description be regarded as illustrative rather than limiting, and that it be understood that it is the following claims, including all equivalents, that are intended to define the spirit and scope of this invention.

We claim:

1. An xSP service provider configured to provide fee assessment and proceeds distribution in response to a transfer of digital content with appended metadata over a network, comprising:
an electronic distribution management system configured to process a notice of completion in response to an acknowledgement of reception of digital content transmitted from one of a primary content receiver and a secondary content receiver, and communicate fee assessment and proceeds distribution instructions;
a fee assessment and proceeds distribution system, in communication with the electronic distribution management system, configured to receive the fee assessment and proceeds distribution instructions and access a receiver/provider management system to determine the fee assessment and proceeds distribution in response to receipt of the fee assessment and proceeds distribution instructions; and
wherein the receiver/provider management system is responsive to the fee assessment and proceeds distribution system to provide access to content receiver and content provider reference information.

2. The xSP service provider as recited in claim 1, wherein one of the primary content receiver and the secondary content receiver is configured to automatically generate the notice of completion upon receipt of digital content with appended metadata which results from electronic redistribution of digital content over the network.

3. The xSP service provider as recited in claim 1, wherein the appended metadata to the digital content comprises descriptive information of the digital content and authorization information for electronic distribution and redistribution of the digital content.

4. The xSP service provider as recited in claim 3, wherein the appended metadata comprises descriptive information for identification of a content provider.

5. The xSP service provider as recited in claim 3, wherein the appended metadata comprises authorization information for a maximum number of distributions of the digital content.

6. The xSP service provider as recited in claim 3, wherein the appended metadata comprises authorization information for a content validity expiration date.

7. The xSP service provider as recited in claim 3, wherein the appended metadata comprises authorization information for content distribution fees payable to the content provider.

8. The xSP service provider as recited in claim 3, wherein the appended metadata comprises redistribution authorization information for a maximum number of redistributions to third parties.

9. The xSP service provider as recited in claim 3, wherein the appended metadata comprises redistribution authorization information for a redistribution validity period expiration date.

10. The xSP service provider as recited in claim 3, wherein the appended metadata comprises redistribution authorization information for royalties to be paid to the content provider.

11. The xSP service provider as recited in claim 3, wherein the appended metadata comprises redistribution authorization information for a content intermediary fee paid to the primary content receiver.

12. The xSP service provider as recited in claim 3, wherein the appended metadata comprises an encryption means for preventing unauthorized modification of the electronic distribution metadata and the digital content.

13. The xSP service provider as recited in claim 3, wherein the appended metadata comprises a means that prevents execution of the redistribution of the digital content if the redistribution process is unauthorized.

14. The xSP service provider as recited in claim 3, wherein the appended metadata comprises a means that facilitates the deletion of the digital content from one of the primary content receiver, the secondary content receiver, a used content store and a used content purchaser terminal that has received an unauthorized distribution of the digital content.

15. The xSP service provider as recited in claim 3, wherein the appended metadata comprises a means that facilitates the deletion of the digital content from one of the primary content receiver, the secondary content receiver, the used content store and the used content purchaser terminal when the term of validity for the digital content has expired.

16. A method for electronically redistributing digital content and compensating an owner of digital content over a network comprising the steps of:
appending an electronic distribution metadata to the digital content;
generating and transmitting a notice of completion, based on information appended in the electronic distribution metadata, upon reception of an electronic redistribution of the digital content;
processing the notice of completion and fee assessments and thereby providing an encryption key for reproducing the digital content upon authorization;
issuing a fee assessment/proceeds distribution processing instruction in response to the received notice of completion; and
performing fee assessment/proceeds distribution for a digital content receiver and a digital content provider.

17. The method as recited in claim 16, wherein the electronic redistributing of digital content is a transmission of the digital content from a primary content receiver to a secondary content receiver.

18. The method as recited in claim 17, wherein the electronic redistributing of digital content is accomplished over a wireless network.

19. The method as recited in claim 17, wherein the electronic redistributing of digital content is accomplished over a peer-to-peer infrared network.

20. The method as recited in claim 16, wherein the electronic redistributing of digital content is one of a transmission of the digital content from a surplus content owner to a used content store and a transmission of the digital content from a used content store to a used content purchaser.

21. The method as recited in claim 20, wherein the electronic redistributing comprises one of negotiating a fee assessment for the digital content between the used content store and the surplus content owner and negotiating a fee assessment between the used content store and the used content purchaser.

22. The method as recited in claim 21, wherein the step of negotiating further comprises obtaining quality assessments of the digital content, the appended metadata for the digital content, a number of copies stored within a database of the used content store and sales activity of the digital content.

23. The method as recited in claim 21, wherein the step of negotiating further comprises analyzing a quality assessment of the digital content, the appended metadata for a number of redistributions allowed, a number of copies stored within a database of the used content store, and sales activity regarding the digital content within the used content store.

24. The method as recited in claim 21, wherein the step of negotiating further comprises utilizing a quality assessment of the digital content, the appended metadata for a number of redistributions allowed, a number of copies stored within a database of the used content store and sales activity of the digital content to determine the fee assessment of the digital content.

25. The method as recited in claim 16, wherein appending of the electronic distribution metadata to the digital content is performed by the digital content provider.

26. The method as recited in claim 16, wherein generating and transmitting the notice of completion, based on information appended in the electronic distribution metadata, is accomplished by one of a primary content receiver, a secondary content receiver, a used content store and a used content purchaser after receiving the electronic redistribution of digital content, to an electronic distribution management system.

27. The method as recited in claim 16, wherein the transmitting of the notice of completion is accomplished by a secondary content receiver to a primary content receiver, which subsequently transmits the notice of completion to an electronic distribution management system.

28. The method as recited in claim 27, wherein transmitting the notice of completion from the secondary digital content receiver to the primary content receiver is accomplished over a wireless network.

29. The method as recited in claim 27, wherein transmitting the notice of completion from the secondary digital content receiver to the primary content receiver is accomplished over a peer-to-peer infrared communication system.

30. The method as recited in claim 16, wherein receiving the notice of completion and providing the encryption key, upon authorization, for reproducing the digital content is accomplished by an electronic distribution management system.

31. The method as recited in claim 16, wherein issuing of the fee assessment/proceeds distribution processing instruction is transmitted from an electronic distribution management system to a fee assessment/proceeds distribution system.

32. The method as recited in claim 16, wherein performing fee assessment/proceeds distribution for the digital content receiver and the digital content provider is accomplished by the fee assessment/proceeds distribution system after accessing information from a receiver/provider management system.

33. The method as recited in claim 32, wherein a settling of accounts between a primary content receiver, which is owed a commission fee for the redistribution of the digital content, a secondary content receiver, and the digital content provider is performed by offsetting a fee with another outstanding fee owed by any party to the transaction.

34. The method as recited in claim 32, wherein providing of the fee assessment and proceeds distribution for an xSP service provider paying third party collection fees is reduced by making regular periodic payments to the digital content provider.

35. The method as recited in claim 16, wherein the fee assessment is first transmitted to one of a primary content receiver, a secondary content receiver, a used content store, and a used content purchaser and upon receipt of an advanced fee assessment by an xSP service provider, the redistributing of digital content is authorized.

36. The method as recited in claim 16, wherein the electronic redistribution and compensating the owner of the digital content is accomplished over a wireless network.

37. The method as recited in claim 16, wherein the electronic redistribution and compensating the owner of the digital content is accomplished over an infrared system for peer-to-peer communications.
